(19) United States
(12) Patent Application Publication
(10) Pub. No.: US 2002/0114431 A1
(43) Pub. Date: Aug. 22, 2002

(54) Caller control system

(76) Inventors: Mark A. McBride, Decatur, AL (US); Lee Maples, Falkville, AL (US); David J. Harris, Helena, AL (US)

Correspondence Address: AUFRICHTIG STEIN & AUFRICHTIG, P.C., FIFTH FLOOR, 300 EAST 42ND STREET, NEW YORK, NY, 10017, US

(21) Appl. No.: 09/920,314

(22) Filed: Aug. 1, 2001

Related U.S. Application Data
(60) Provisional application No. 60/222,507, filed on Aug. 2, 2000.

(51) Int. Cl. H04M 1/64

(52) U.S. Cl. 379/88.21; 379/67.1

(57) ABSTRACT

A Caller Control System designed to give a person with a telephone full control of their phone calls by providing, in addition to Caller I.D. the ability to send unwanted calls directly to a Voice Mail system without causing the phone to ring.

This application claims priority from Provisional Patent Application No. 60/222,507 filed on Aug. 2, 2000.

### BACKGROUND OF THE INVENTION

The invention is generally directed to a software/hardware telecommunications solution that provides total control of a telephone, whether that telephone be a corded land phone, cordless phone, wireless phone, cellular phone, digital phone, global satellite phone or any other type of phone product.

This control is possible through software and hardware technologies, and can be implemented in the software of a telecom vendor's equipment, in a hardware and/or software product of a business or household telephone or personal computer, telephone system and/or telephone equipment, and/or in the infrastructure of any telephone manufacturer's product with our software chip.

The Caller Control System (“CCS”) allows a recipient of a telephone call to restrict and control access to his or her telephone by all callers, and limit incoming calls to only those that are desired by the recipient. Up to now, the products that allow recipients of telephone calls to restrict and control access to their phones has been very limited. Caller I.D. systems allow recipients to view incoming caller's information, but does not allow any control or restrictions. Call blocking features allow recipients to block only callers that intentionally block their calling information. Privacy Directory allows recipients to screen callers, but once again does not allow any real control and restrictions. Government Telemarketing Restriction Lists allow recipients to be listed as people who do not wish to be called by telemarketers, but do not guarantee that calls will not be made. These and many other products exist in the marketplace today, but none give recipients and telephone users the control that the Caller Control System (“CCS”) does. It seems that products and services continue to be introduced but nothing has ever been introduced that will finally give telephone users privacy and control. The CCS gives telephone users COMPLETE CONTROL of their telephones.

In today's world, people are very busy and time is a very valuable asset to most. Whether you are a student, parent, worker or all of the above, being able to control your time is very important. This is why the CSS was invented!! In addition to people being busy, other problems exist that give the CSS value. The problems cause people to want to be able to control unwanted calls and harassing calls from unwanted telemarketer, exspouses, ex-friends, ex-employees, unhappy people in the community, solicitors of donations, scam artists, bill collectors in breach of collection laws, and many others.

The problems, when it comes to the value of time and controlling your calls, speak for themselves. The problems, when it comes to unwanted and harassing telemarketing calls, are so serious that the Government has been getting involved over the latest few years. The problems, when it comes to all other reasons for wanting to control your phone, are personal privacy issues that are most important on an individual basis. The bottom line is that no matter what the problem may be and what the reason may be for wanting control, we believe that every household and business in the world wants to be able to control their telephones and the CCS can make this possible.

The need for the product is directly related to the problems. If the CSS could allow people to have full control of their phones, while curing all the many problems related to not having full control and privacy, then the CCS would be a revolutionary solution to the telecommunications industry all over the world.

Although the Caller I.D. system has improved the ability to screen the source of incoming calls, there are substantial deficiencies in this system. In particular, many of the callers have blocked their Caller I.D. information so that no information is provided to a recipient about the caller. This can be accommodated either through a limited restriction on a particular call or through a uniform blocking of Caller I.D. information from a destination. This is particularly problematic with respect to telemarketer, solicitors, bill collectors or others who seek to gain access to an individual through the phone system without allowing the recipient to identify the source of the call prior to picking up the telephone. Accordingly, there is a need for people to have the ability to not receive calls from anyone that should not be calling, whether it is ex-friend, an ex-spouse, an ex-employee, an unhappy person in the community, a telemarketer, a solicitor, a scam artist at work, or a bill collector who is in breach of collection guidelines. There is a need for the telephone equivalent of spam (unwanted Internet communications) from land communications to be weeded out without an individual having to take any affirmative steps or to answer the phone in these cases.

When the CCS was only an idea, there were many goals and objectives for developing the product. One could spend days sitting around thinking of hundreds, possible thousands, of reasons why people need full control of their telephones. When thinking all of these reasons through, they all stem from a few basic realities, namely:

People do not want to be interrupted by untimely telemarketers.

People do not want to be bothered by telephone donation solicitors, since most people have their personal charities and community involvement.

People do not want to be bothered by “old flames” whether they be ex-wives, ex-lovers, ex-boyfriends, ex-girlfriends or just an old friend with whom there was a “falling out.”

Employers do not want to be bothered by ex-employees, disgruntled or unhappy workers, or untimely calls during non-working hours.

People do not want to be bothered and/or harassed by bill collectors that do not follow collection guidelines, or by credit card companies that are overdoing the marketing of trying to make you a customer.

People do not want to be interrupted by wrong numbers.

People do not want to be bothered by prank callers and/or other type of joking and/or threatening callers.

The list could continue on and on, but the basics have been covered.

The objective of the CCS is to cure all of these problems, and give every telephone user full control and privacy. The CCS, however, has taken all the products and services that assist with the solution and “bundled” them all together into one software product, one hardware/software product, and/or one single hardware/software chip to make the control and privacy finally possible.

### SUMMARY OF THE INVENTION

The invention is generally directed to a Caller Control System which is a software program designed to give any person with a telephone full control of their phone calls by providing, in addition to Caller I.D., a call blocking feature available to reroute calls made by people who intentionally try to keep from being recognized on Caller I.D., and to send any unwanted calls directly to a voice mail system without causing the phone to ring.

Accordingly, it is an object of the invention to provide an improved Caller Control System which restricts access and which automatically handles calls not authorized to be run directly through to a voice mail system for later review at a user's leisure and convenience.

Another object of the invention is to provide an improved Caller Control System which works with Caller I.D. to restrict access to the phone call recipient if the caller restricts access to its information.

Still another object of the invention is to provide an improved telecommunications system which enhances the Caller I.D. system to remove unwanted and undesired telephone calls and prevent telephone harassment.

Yet still another object to the invention is to provide a Caller Control System which provides a telecommunications solution to restricted access to a phone number such that the phone user has an ability to customize the response and provide password control access to the phone number for desired callers.

Still other objects and advantages of the invention will, in part, be obvious and will, in part, be apparent from the specification.

The invention accordingly comprises the features of construction, combination of elements, arrangement of parts, combinations of steps and procedures, all of which will be exemplified in the constructions and processes hereinafter set forth and the scope of the invention will be indicated in the claims.

### BRIEF DESCRIPTION OF THE DRAWINGS

For a fuller understanding of the invention, reference is had to the following descriptions taken in connection with the accompanying drawings, in which:

FIG. 1 is a flow chart diagram of a Caller Control System constructed in accordance with a preferred embodiment of the invention.

FIG. 2 is a flow chart diagram of a Caller Control System constructed in accordance with another preferred embodiment of the invention.

FIG. 3 is a flow chart diagram of the Caller Control System of FIG. 2 incorporating the Ring Processing portion of the flow chart diagram.

FIG. 4 is a flow chart diagram of the Caller Control System of FIG. 1 including further Ring Processing functions.

FIG. 5 is a flow chart diagram of the Caller Control System of FIG. 2 including System Management features of the Caller Control System.

FIG. 6 is a flow chart diagram of the Caller Control System of FIG. 2 including further elements of the Caller Control System to enable processing.

FIG. 7 is a flow chart diagram of the Caller Control System of FIG. 2 including the Voice Mail processing functions.

FIG. 8 is a flow chart diagram of the Caller Control System of FIG. 2 incorporating the Voice Mail Administration processing functions.

FIG. 9 is a flow chart diagram of the Caller Control System of FIG. 2 incorporating the Answer Options processing.

FIG. 10 is a flow chart diagram of the Caller Control System of FIG. 2 including the Lock process and Do Not Disturb features of the process.

FIG. 11 is a flow chart diagram of the Caller Control System of FIG. 2 incorporating the Ring Processing and Caller I.D. features of the process.

FIG. 12 is a flow chart diagram of the Caller Control System of FIG. 2 incorporating the Leave voice Mail and Release Phone Line and Resume Polling features of the process.

### DETAILED DESCRIPTION OF THE PREFERRED EMBODIMENTS

The technical aspects of the functionality of the product are very elaborate and the design has many options for development and usage, though, all functions and options work the same in the end and revolve around the locking system of the product. The user's view of the functionality of the product, however, is very straight-forward and simple in theory. You can lock and unlock you phone, giving you full control of your phone—it's that simple!

The product is designed to work with or without Caller I.D.

The product is designed to work with or without voice mail products and/or answering machines and devices.

The product is designed to work with any type of telephone.

The product is designed to work with telecommunications products and services offered in phones, phone systems and vendor equipment.

The product is designed to work with or without computer integrations.

The product is designed to work with or without use of the internet.

The product is designed to work as a software product.

The product is designed to work as a software/hardware product.

The product is designed to work as the only hardware/software single-chip product of its kind.

Knowing the many design features of the product, one can understand how the product works when viewing the drawings and flow chart of the functionality of the product. The following pages will explain how the product works from when a call is placed by a caller to when the call is received by the recipient of the call. The drawings and flow charts will show the technical description of the product.

When a call is placed by a caller, a caller simply picks up the phone and dials a phone number and within seconds the recipient's phone will ring. This is the process that the average user sees, but does not show all the different steps that take place while the call is being processed from one end to the other.

When a telephone call is made, a caller picks up the phone, listens for a dial tone, and then dials the number. If it is a cellular or wireless telephone, a send button may be pushed after the number is dialed. Once the number is dialed or the send button is pushed, the call is routed from the caller's location/local service provider/service area, through the computer systems, and on to the location/local service provider/service area of the recipient. Once the call is received by the recipient's location/local service provider/service area, it is processed through the computers that control all the features and options the recipient uses with their service.

At this point, Caller I.D., Call Blocking, Voice Mail, Privacy Directory, and all the other features and “bells and whistles” work together within seconds or fractions thereof, before the recipient's telephone rings. Many of the products and services the recipient uses and/or subscribes to are controlled by the vendor's equipment, while some are just “plug-ins” to the phone within the recipient's home or office. During this process, before the phone rings, the products and services being utilized by the recipient are either software products within the vendor's equipment or hardware/software products not within the vendor's equipment. Everything is working together until the call is completed.

The one product/service that does not exist is a feature that allows one to “lock” and “unlock” their phone, in an effort to take full control of the telephone. This is where the CCS comes into the picture.

Whether the CCS is a software product incorporated in with the Vendor's equipment or the user's personal computer or a software/hardware product in the form of a box that your telephone plugs into, the CCS features a locking system that controls what calls ring to the recipient's phone and what calls are routed to voice mail, answered by the answering machine, or never answered.

The CCS can be turned on or off at all times. When the CCS is “OFF” the recipient's telephone will ring and calls will be routed as usual. However, when the CCS is “ON”, the call will be intercepted and routed according to the locking setting. The CCS will allow recipients to lock their phone when the CCS is “ON” and only accept calls from callers that know the “pass code” or have the “key” to enter. The caller will hear a personalized greeting stating something to the effect of “You have reached the home of John Doe and your call is being secured by the Caller Control System. If you know the password, please enter it now and your call will be put through, or you may leave a message and we will return your call as soon as possible.” Of course, this greeting will change depending on the availability of voice mail and/or an answering machine.

Once the call has been intercepted by the CCS, the caller's call can only be put through to the recipient with the “pass code” or “key”. The pass code has two ways of being used—manual or automatic. Whenever the CCS is set “ON” there is an automatic pass feature that allows all calls in your call directory to be automatically put through. This allows you to decide who can and who cannot call, while allowing your callers the convenience of being on your “buddy list”, without always having to remember people's CCS pass codes. If someone is on the list, their call is put through without the greeting as well.

For callers not on the list, the only other way to have your call put through is to know the manual pass code and enter it when prompted. Once the pass code is entered the call is put through as usual, and as the automatic pass code.

In the event the caller is not on the list and does not have the pass code, their call will either be routed to voice mail, retrieved by an answering machine or will go through the ringing process until the call is terminated (but not ringing and being heard by the recipient). This is the key element to the patent—the locking system that keeps the calls from entering your home or office without your approval, whether it be automatic or with permission.

The CCS product will work with any phone, anywhere. If the phone service provider offers the product, no product purchase will be required of the buyer, only service subscription. If the telephone user is not offered the product, or does not wish to pay for the product as an added service feature, the other option will be to purchase a software/hardware product that will basically do the same thing as the service. In both situations, the product is designed as a software/hardware solution, and the CCS may or may not be implemented as a manufacturing single-chip design.

In accordance with a preferred embodiment of the invention, the Caller Control System is a software program designed to give any person in the world with a telephone full control of their phone calls. Even though a person rents telephone service for a monthly fee, that person should have control of the incoming calls. Caller I.D. was made available many years ago for the specific purpose of giving the receiving end of a call (hereafter “the Receiver”) the opportunity to know who is calling. As the Caller I.D. service has improved, it is now possible to see both the number and the name of the person who is calling. In many locations it now possible to view both the name and the address of the caller and incoming calls can be tagged through call-waiting features. In addition to Caller I.D., there is also a call blocking feature available to reroute calls made by people who intentionally try to keep from being recognized on Caller I.D. The caller blocking feature, if enabled, advises someone with a blocked telephone number that the receiver has indicated that it will not accept any calls from blocked numbers and that, unless they are willing to disable the call blocking feature, their call cannot be completed. Furthermore, there are various features that allow a receiver to forward calls directly to a voice mail system and avoid being bothered with calls until they are ready to receive them. While all of these features and products are improvements and provide high quality service, there is a substantial gap in these features in providing a Receiver with a high quality useful telephone system.

Applicants' Caller Control System provides a means for enhancing the currently available features so that the Caller Control System will automatically take a call that cannot be identified by Caller I.D. or is not an acceptable call and reroute it to a system which will prompt the caller with “Your call has been answered by the Caller Control System. The person you are calling will not accept calls from anyone who cannot be identified unless you know the password . . . please enter the password now and your call will be put through . . . otherwise press “1” to have your call delivered to voice mail or press “2” if you are placing a collect call. The Caller Control System is designed to protect people from harassing calls, undesirable telemarketing and to give the receiving end of a call real privacy and real control of the phone which they are paying money to use in a useful fashion.

The Caller Control System will improve telecommunications in a way that will revolutionize the use of the phone and telephone. It improves the enhanced features offered by Caller I.D. and makes it better than ever. It allows people to never receive calls from anyone that should not be calling, whether it be an ex-friend, ex-spouse, ex-employee, telemarketer, solicitor, scam artist and basically takes out all of the Spam (unwanted Internet communications) from land communications and allows people to control those unwanted and undesired calls. In addition, it solves problems of telephone harassment and will cut down on criminal activities related to this specific area of telecommunication crimes. It will finally give every person in the world a real sense of privacy and a true control of their telephone. The Caller Control System is one of the many products created for the telecommunications application, but is the first product ever developed that is truly beneficial to every telephone user and has been designed with everyone's best interest in mind.

The caller control system can be marketed through ILECs BLECs and CLECs around the world to the end user. Since the product utilizes Caller I.D. and voice mail, it can be used as an offered feature by a phone carrier, and it can increase the sales of other features and products. There are hundreds of millions of people in the world with phones in their homes and offices. Of this number, there are tens of millions of peoples who subscribe to Caller I.D. and other additional features. With ILECs, BLECs and CLECs around the world offering the product with their trade name or trademark, the potential earnings from the product would be truly unbelievable.

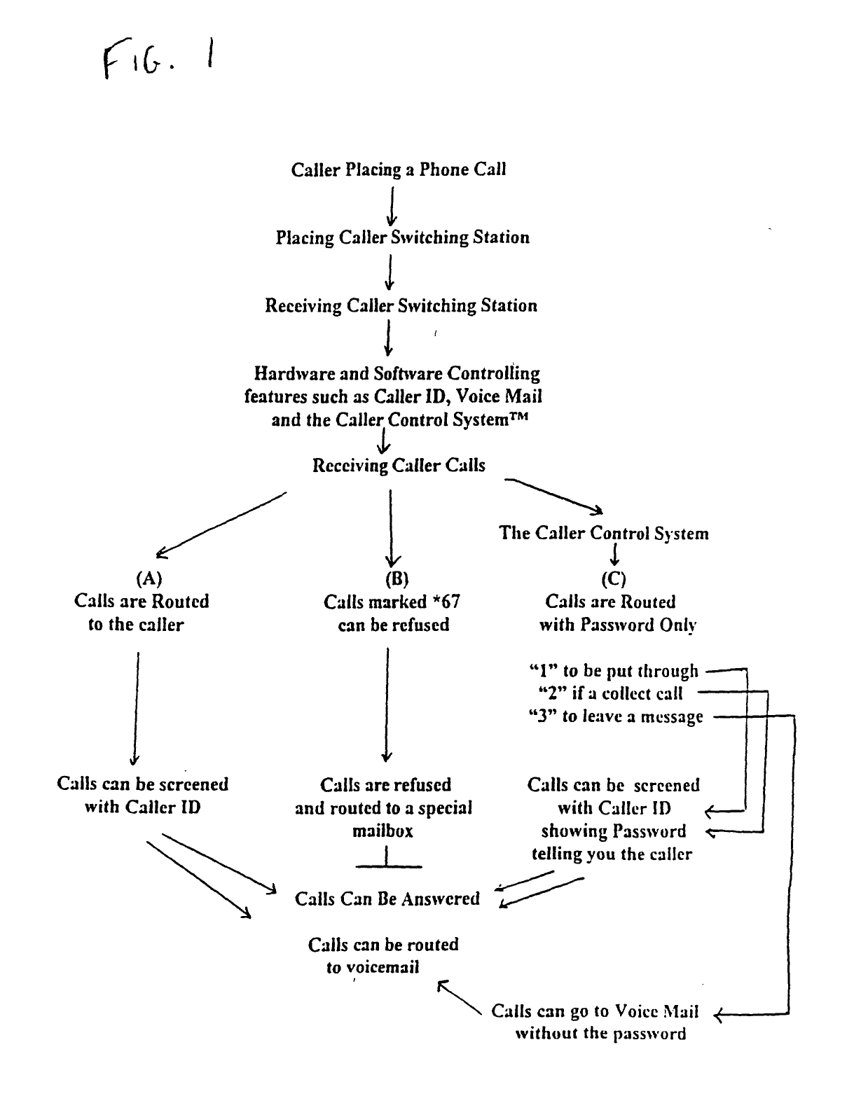

Reference is next made to FIG. 1 wherein a functional flow chart of a simple embodiment of the invention is depicted. Starting at the top and moving down, a caller places a phone call which passes through the caller switching station. The call then goes to the receiving caller's switching station where hardware and software controlling features such as Caller I.D., voice mail and the Caller Control System are present. Calls for the receiving caller are then directed in either of three routes. In the event that Caller I.D. information is available from the caller, Pathway A is used and the calls are routed to the caller where the caller can screen the calls with Caller I.D. Then, either the calls can be answered or the calls can be routed to voice mail by answering the telephone.

Next, if the calls are marked *67, which is the telephone system code for blocked calls which refuse to provide Caller I.D. information, the calls can be refused and routed to a special mailbox for such calls where a message can be left or the caller can be advised that, by pressing an appropriate key, it can release its Caller I.D. information and be passed through to the receiver. Finally, in the event that the caller does not have the Caller I.D. information available, the Caller Control System can play its message which requires that the caller either release the call blocking information or enter a password. The password can be provided by the Receiver in different classes or a single password for all authorized callers. If the caller has the appropriate password then it will be passed through the Caller Control System which then allows the caller to either be put through by pressing “1”, put through to the collect calls system by pressing “2” or going to voice mail by pressing “3”. Generally, different voice mail boxes can be enabled for those callers who have the password and those who do not and who are screened out. Multiple mailboxes for different classes of people with different authorized passwords can also be established. In the event that a caller enters the Caller Control System but does not have an appropriate password, their call can still go to voice mail, but, in a preferred embodiment, would go to the general voice mail for calls marked “*67”.

Accordingly, an improved telecommunications product including a Caller Control System which provides increased control of incoming calls which have blocking or privacy restrictions is provided.

At the core of the CCS is a powerful digital signal processor (“DSP”). This simple central controller monitors, in real time, all the activities on the home phone network. Phone line processing is achieved via a supervisory loop running on the DSP. This processing loop, coupled with some discrete electronic hardware for detecting voltage and current changes on the line, provide instantaneous responses to incoming calls. The CCS comes in different levels. The first level, considered the basic, provides all of the protection but not all of the optional functions available on the CCS. Then there is the standard product. This version contains all of the functions of the basic model plus more convenience features. The advanced model embodies all of the other functionality plus other options, such as an integrated phone.

The CCS has several system loops that run concurrently. The ring processing loop (“RPL”), the user interface loop (“UIL”), the supervisory loop (“SL”) and the system monitoring loop (“SML”).

The ring processing loop does exactly what it sounds like plus some. This section of the DSP continuously monitors the phone line for an incoming call. While doing so it also “listens” to the line for user input for system management via DTMF. It also detects and gathers CID/CWCID data. Ring generation as needed is performed in this loop as well. There are several optional parameters associated with this processing task. This is the section that is responsible for watching stored parameters and comparing them to user and phone activities. The default system parameters are also compared with user enabled optional parameters. Lets walk through an incoming call for the ring processing loop. Just prior to an actual phone ring being received from the Telephone Company (“Telco”), the phone line is sent a preamble signal. This is detected and is used as an interrupt for the system to wake from a lower power mode. This takes less than one microsecond and allows the CCS to utilize much lower power consumption modes when possible. Once the CCS has moved into a normal power/operational mode the first ring is almost there. When the first ring is detected the system “catches” the CID data between the first and second rings. The instant the CID data is collected an optimized lookup table is scanned for a matching phone number. If a matching phone number is located and the user hasn't set the CCS for complete privacy the call is allowed to ring through to the rest of the house. The CCS ring processing loop continues to monitor the phone line and counts the rings. If the CCS voice mail system is available and enabled the RPL waits for the terminal ring count to be reached. Once this count is reached the CCS RPL picks up the phone and prompts the caller to leave a message for the appropriate mail box. If the distinctive ring function is enabled and the user as this option from the Telco, the caller will automatically be dumped into the correct mailbox. There the caller can hear the canned greeting or the user could have replaced that greeting with their own. Once the caller has left a message, numerical or voice, there are advanced features that, if enabled, allow the caller to mark the message as urgent, important, private or for normal delivery. No matter which mail box this message was placed into, a general mail box or a personal mail box, the user can have this message forwarded on to another device. If available on this unit and enabled, the user can provide alternate delivery to each of the five (5) mail boxes. The voice mail can be forwarded to another phone or the number can be forwarded to a pager. An optional interface to a PC can even allow for the voice mail or phone number to be e-mailed, while another optional interface even allows for faxes to be received, then e-mailed to another location. Once a message is received, the caller information is stored in the CID memory and if a message was left an attentiongetting device is enabled. Normally this is a LED blinking on the unit. However, this can be disabled and only a note placed on the display.

RPL process for an incoming call that isn't on the Approved Caller Look Up Table (“ACLUT”) is as follows. Once an incoming call is detected, the CID data is gathered but isn't in the ACLUT, or isn't available at all. The caller is dumped into the locking mechanism. If the call was received on a distinctive line ring and distinctive ring processing is enabled, that is logged into the data for that call event. Once the call is in the locking mechanism the caller is prompted with either the canned greeting or a user replaced greeting and allowed to either enter a pass code allowing the caller to get through, or leave a message so that the user can get back with them, or not. If the caller has an active/good pass code, the caller is placed on hold (the phone line is held so that the caller isn't dropped) and the CCS generates a ring causing the phone inside the house to ring. Once the user picks up the phone the CCS releases the line on hold to the user. If the user doesn't answer and voice mail is enabled the user will be routed to voice mail.

The UIL's main task is to monitor input functions either via DTMF functions processed by the RPL or actual buttons on the CCS unit itself. When the UIL detects input on the unit itself the input signals are decoded, processed with data being displayed on the unit's LCD panel. System functions are available from the buttons on the units. These functions are System Enabling, Caller I.D. Functions, Privacy Options, Voice Mail and Optional Function Management.

System enabling is the menu function for setting and managing CCS operational level. The CCS's levels of operation include 0—Power Off, 1—Disabled except for CID functions, 2—Enabled for normal operation, and 3—Enabled for maximum privacy. Power off means exactly that. When the unit is off it consumes only a minimal amount of power. The power consumed is only enough to display the time and monitor the input for power on request. Power input is monitored via the SML. The SML gets a pointer from the UIL allowing the SML to process user input in special events, such as sleep mode (a/k/a power off) . When the unit is completely disabled the CCS can still log Caller I.D. information, but otherwise the system allows the phones in the home to function normally. Enabling the CCS for normal operation allows all incoming calls to be monitored. Incoming calls meeting required parameters are passed through to the user in a normal fashion as if the CCS were transparent. Privacy mode causes the CCS to intercept all incoming calls, approved or not approved. Approved calls are routed to the appropriate voice mail. Unapproved calls are automatically dumped to the locking mechanism. While in privacy mode, data is displayed in a more enhanced manner. A list style is adopted during privacy mode to provide the user with an easier view of the calls.

The system voice mail options can be managed globally or for a specific mailbox. These options include: 1) Personalized or Canned Greetings, 2) Multiple Unique Pass Codes, 3) Multiple Unique Pass Codes for Remote Mailbox Management, 4) Message Notification Options, and 5) Voice Processing Options.

The CCS allows the user to keep the greetings provided with the unit, or to replace them with customized greetings. These greetings can be personalized or customized for each of the five mailboxes, and each mailbox can be assigned a distinctive ring. Each mailbox can be assigned unique notification options. These options include: 1) Voice Mail Forwarding, 2) Incoming Number Forwarded to Your Pager, 3) Call Receive Notification and 4) Voice Mail Forwarded as E-mail (this requires a PC Interface).

The CCS allows the user to manage the complete system from a remote location. The system has a master pass code that allows for this complete system management. Mailbox owners can update their mailbox settings from any phone line via DTMF coding on a touch tone phone.

Once a message has been retrieved, it can be saved for future reference, deleted, or transferred to another mailbox. It is possible to scan forward or backward through the messages via a phone keypad. Moving these message pointers through message memory is handled by the UIL. All system memory is shared memory and any process can access it at any time. Arbitrary updates are managed via block locks. These block locks are controlled and managed by the SML.

All CID data is stored for all incoming calls with CID information. This data is collected and stored even if the call is dumped to the locking mechanism. This allows for easy call to address book or approved number list. The Caller I.D. module, handled by the RPL, is where the approved list is maintained. If an incoming caller leaves a message it will be noted beside their CID information, along with the path the caller took, such as through the locking mechanism, distinctive ring, pass code, etc.

The CCS, in a current preferred embodiment, contains two option ports. These are built to comply with the compact PC card standard. This port is proposed as an open architecture design platform. These options include, but are not limited to, USB PC interface, Ethernet PC interface, fax interface and additional memory storage. As communications and PC standards change, the ports can similarly be adapted.

With the PC interface option all data stored in the CCS can be edited or manipulated from a standard computer running Windows 9x/WinNT/Win2k. With a properly configured computer, the CCS provides the option of mailing an audio file, Caller I.D. information, and time/date stamp to a specified e-mail address. This option also enables the user to synchronize contract lists and add approved callers from external sources in a user-friendly environment. This option also allows for backups in the event of memory corruption.

With the fax interface the CCS user can accept incoming faxes and automatically or manually send them to any standard fax machine or PC fax board. Fax options are automatically added to the menu stack when the fax option is installed.

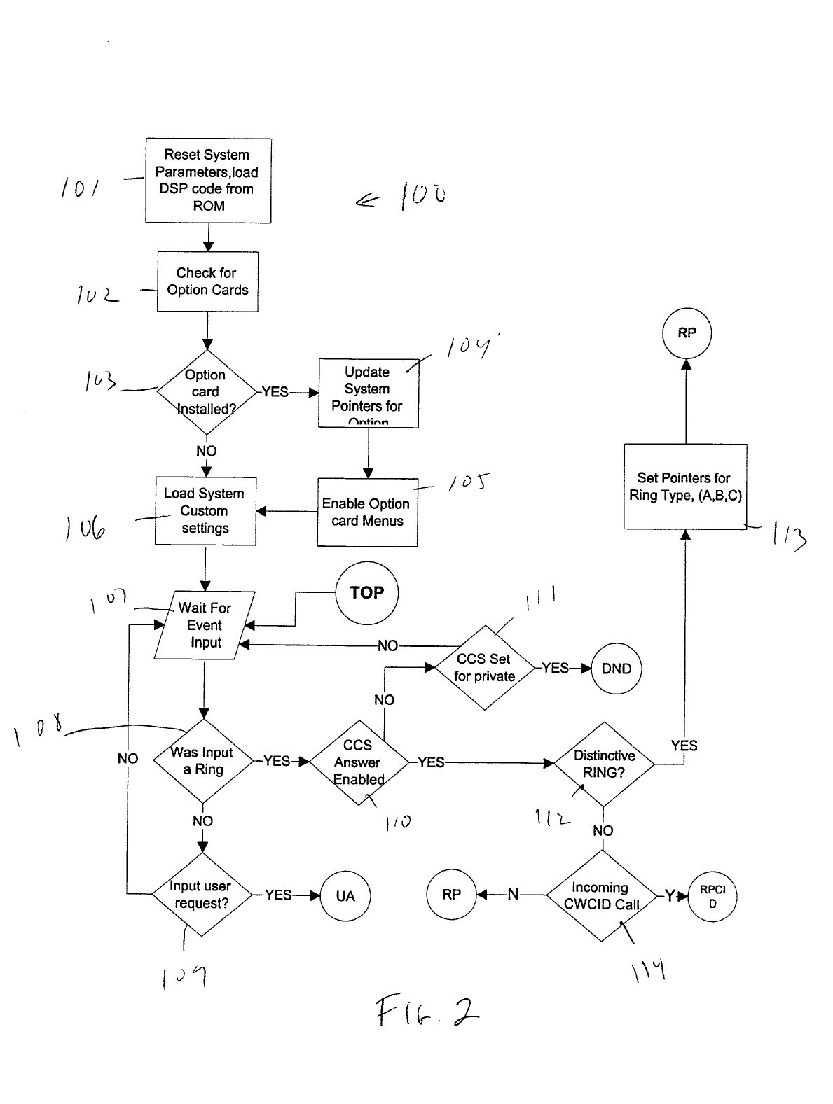

Reference is next made to FIGS. 2-12, wherein the Caller Control System Operational Flow in accordance with another, more preferred embodiment of the invention is depicted. CCS operational flow 100 commences on FIG. 2 and then moves from FIG. 2 to various of the other figures depending upon branching information. The circular symbols with capital letters inside them on FIG. 2 and the subsequent figures are linking symbols which link to an operational flow at one of the other figures.

In Box 101, the beginning of Operational Flow 100, system parameters are reset and the digital signal processor (“DSP”) code is loaded from a ROM.

Next, in Box 102 the system checks for option cards. In branching Box 103, a determination is made whether the option card is installed. If yes, then in Box 104 the system pointers for the option are updated, the option card menus in Box 105 and the system custom settings are loaded in Box 106. If no option card is installed at branching Box 103, the flow goes directly to Box 106. These flow elements are generally only done when the CCS is started up.

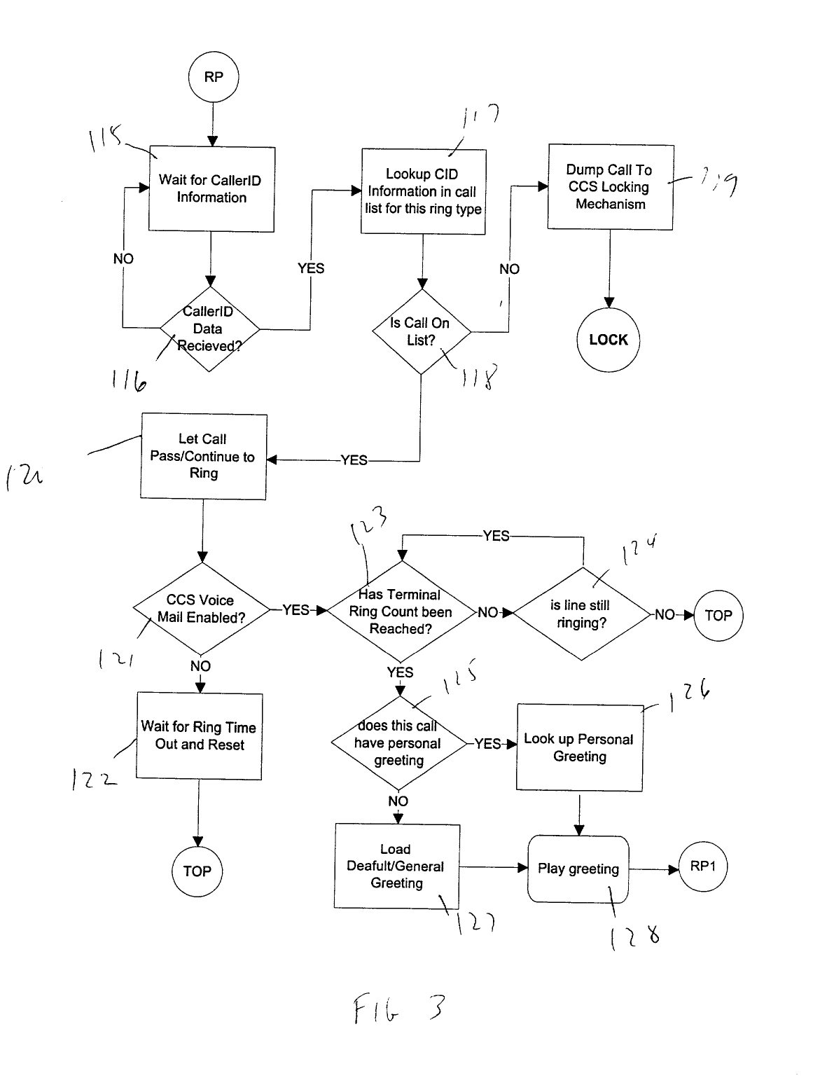

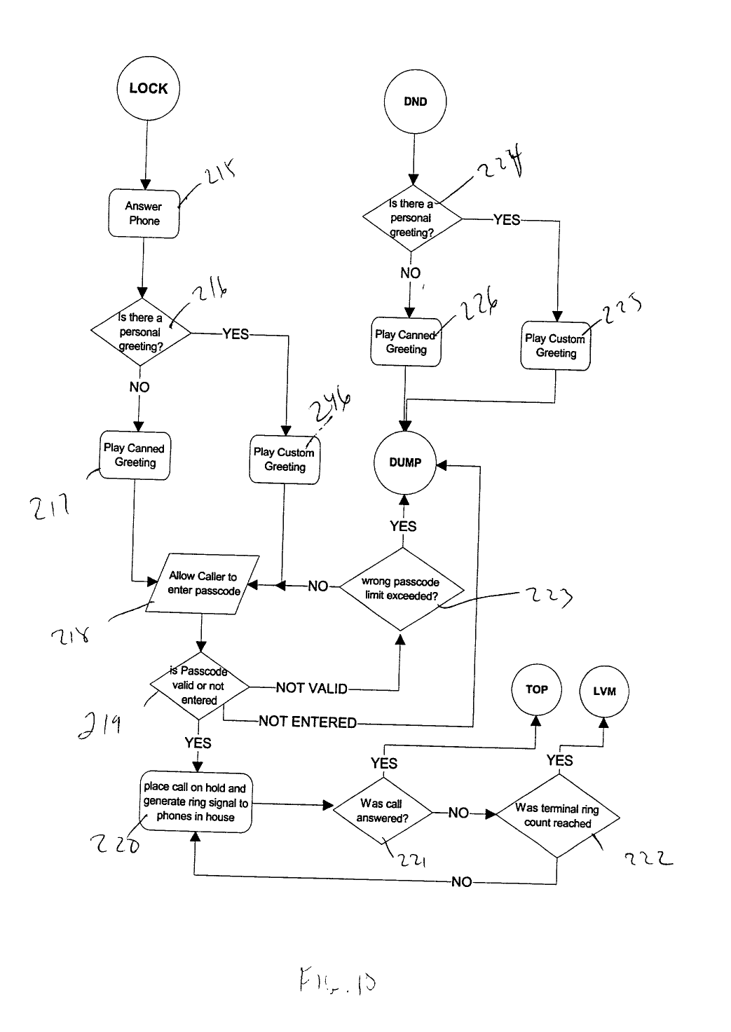

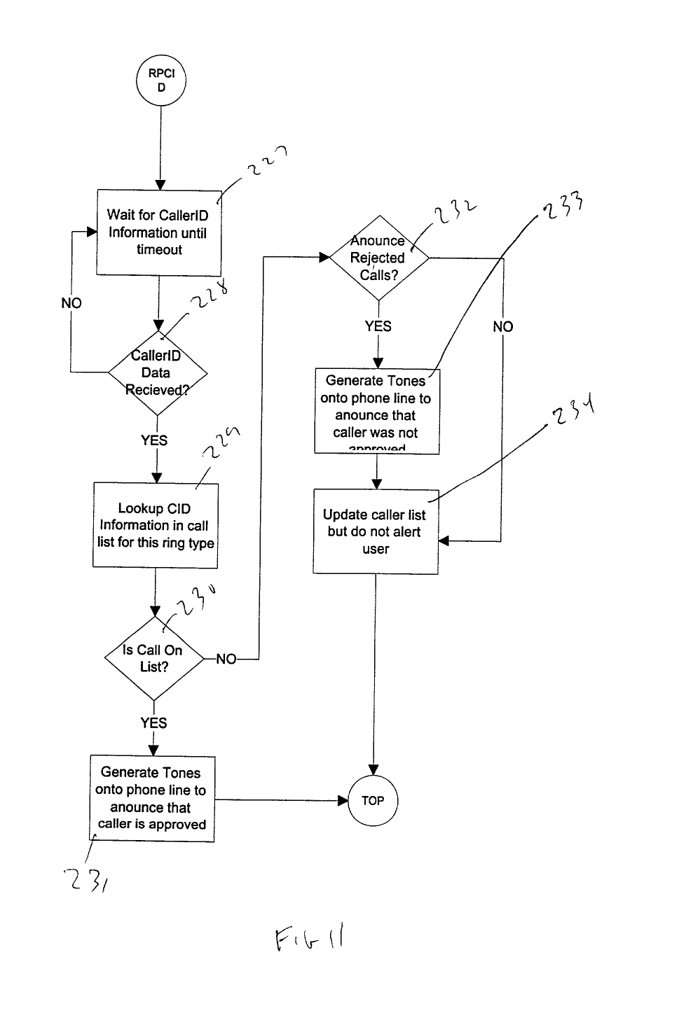

Next, in Box 107, the system waits for an event input. This is also the “TOP” of the Caller Control System Operational Flow and where later branching elements referred to return to the TOP return. When an event input is received, the flow moves to branching Box 108, where a determination was made if the input was a ring. If yes, then the CCS determines in branching Box 110 whether an answer was enabled. If no, then the process moves to branching Box 111, where a determination is made whether the CCS is set for private operation. If no, then the flow returns back to Box 107. If the CCS is set for private function, then the process flow advances to process “DO NOT DISTURB” (“DND”), which is found in FIG. 10. If in branching Box 110 the CCS answer is enabled, then the flow is directed to branching Box 112, where a determination is made whether there is a distinctive ring. If yes, then the flow continues to Box 113, where pointers for the ring type (A, B, C) are set, and then the process flow continues to link with ring processing (“RP”), which is found in FIG. 3. If there is no distinctive ring found in branching Box 112, process flow shifts to branching Box 114 to determine if there is an incoming Call Waiting Caller I.D. call. If not, then the flow shifts to process RP in FIG. 3. If yes, then the process shifts to the ring processing for Caller I.D. (“RPCID”) found in FIG. 11. If in branching Box 108 it was determined that the input was not a ring, then the process flow shifts to branching Box 109, where a determination is made whether the input is a user request. If so, then the process flow shifts to the User Access (“UA”) process flow. The User Access can be set at whatever activity is indicated. If the input is not a user request, then the process flow returns to Box 107 to await a further event input.

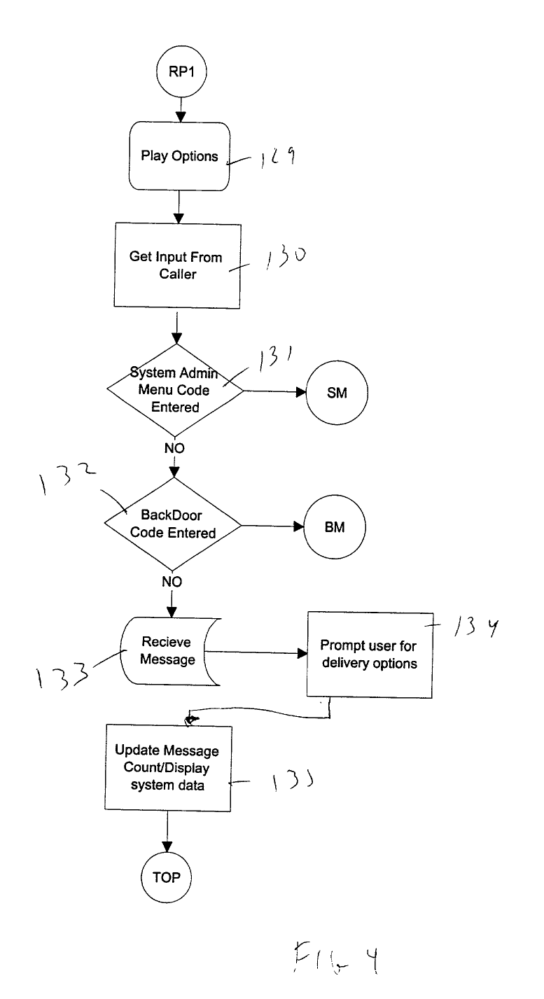

Reference is next made to FIG. 3, wherein the Process Flow for the Ring Processing is shown. In Box 115, the process waits for Caller I.D. information to be received. If Caller I.D. data is received in branching Box 116, the process flow advances to Box 117, where the Caller I.D. information in the call list for this ring type is looked up. Otherwise, the process flow returns to Box 115. Next, in branching Box 118, a determination is made whether the Caller I.D. received is on the approved list. If not, in Box 119, the call is dumped to the CCS locking mechanism in accordance with the lock procedure found in FIG. 10. If the call is on the list, then the process flow continues from branching Box 118 to Box 120, which allows the call to pass and the phone to ring. Next, in branching Box 121, a determination is made whether the CCS voice mail system is enabled. If not, in Box 122, after waiting for the ring to time out and reset without anyone picking up the phone, the process returns to the TOP, as shown in FIG. 2. On the other hand, if the CCS voice mail system is enabled, in branching Box 121, the process flow continues to branching Box 123, where a determination is made whether the terminal ring count has been reached. If not, a determination is made whether the line is still ringing. If so, then the flow returns to Box 123. Alternatively, if the line is not still ringing, then the process flow returns to the TOP. Once the terminal ring count has been reached in branching Box 123, flow shifts to branching Box 125, where a determination is made if this call has a personal greeting associated with it. If so, in Box 126, the system looks up the personal greeting and, in Box 128, plays that greeting before continuing to a Ring Processing One (“RP1”) process flow in FIG. 4. Alternatively, if the call does not have a personal greeting, the process flow shifts to Box 127, where a default or general greeting is loaded and then played in Box 128, prior to shifting to process RP1.

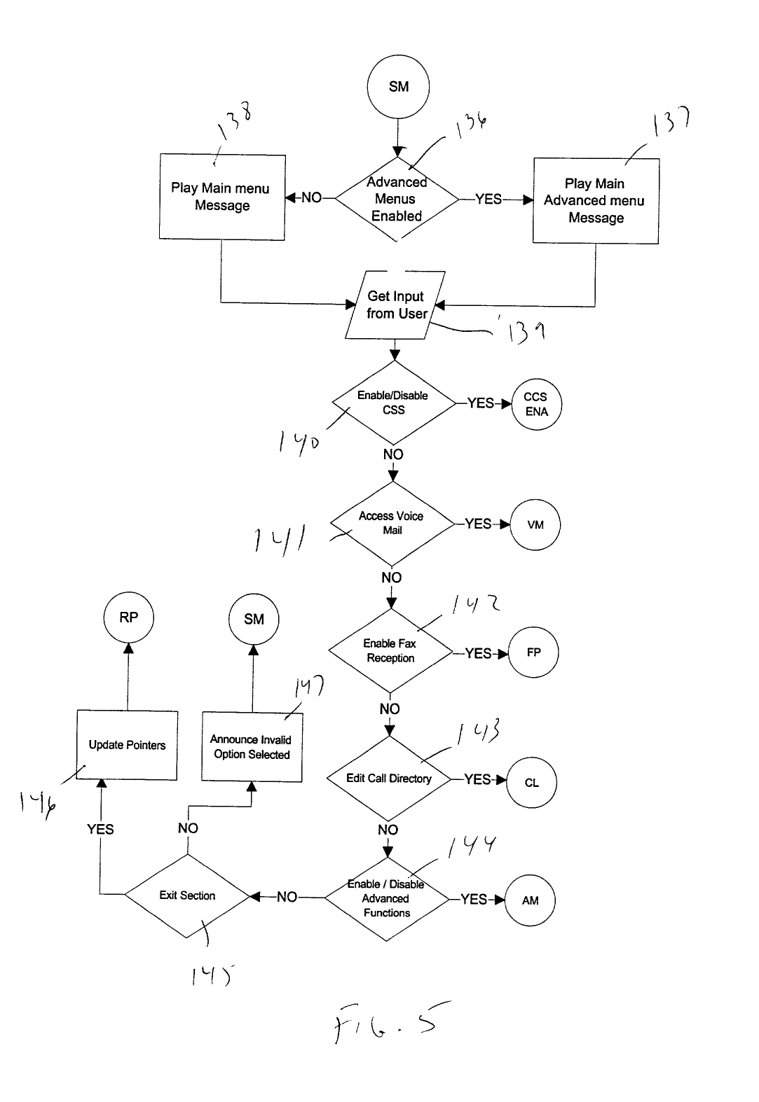

Reference is next made to FIG. 4, wherein the RP1 Process is shown. In Box 129, play options are performed, input is received from the caller, generally in the form of either voice input or DTMF tones received by pushing buttons in Box 130. Next, a determination is made whether system administrator menu codes have been entered. If so, the process shifts from branching Box 131 to the System Management Process Flow found in FIG. 5. If not, a determination is made in branching Box 132 whether a backdoor code has been entered. If so, then processing shifts to a Backdoor Management (“BM”) process, which is not shown. The Backdoor Process can be used to override certain features and provide similar abilities as the System Administrator menu code provides. Generally, the Backdoor Code would be utilized by the programmers or a telephone company to upgrade the system or otherwise make system changes. If no Backdoor Code is received, then the system receives the user's message in Box 133 and then prompts the user for delivery options in Box 134. Following processing of the message with the delivery options, the system updates the message count and displays system data in Box 134 before returning to the TOP.

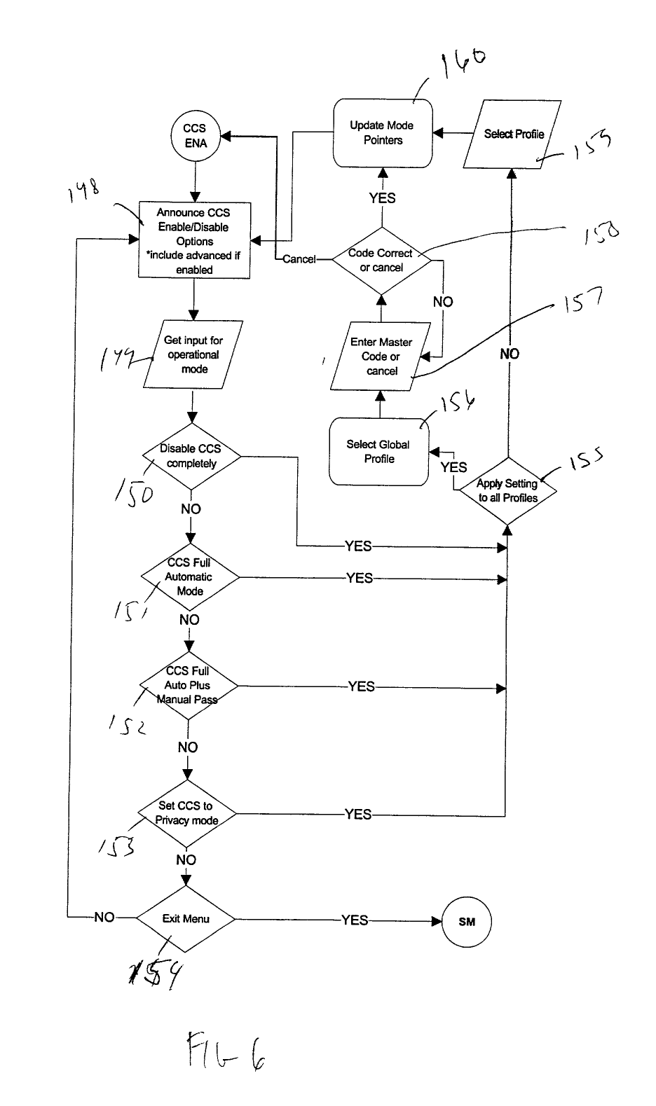

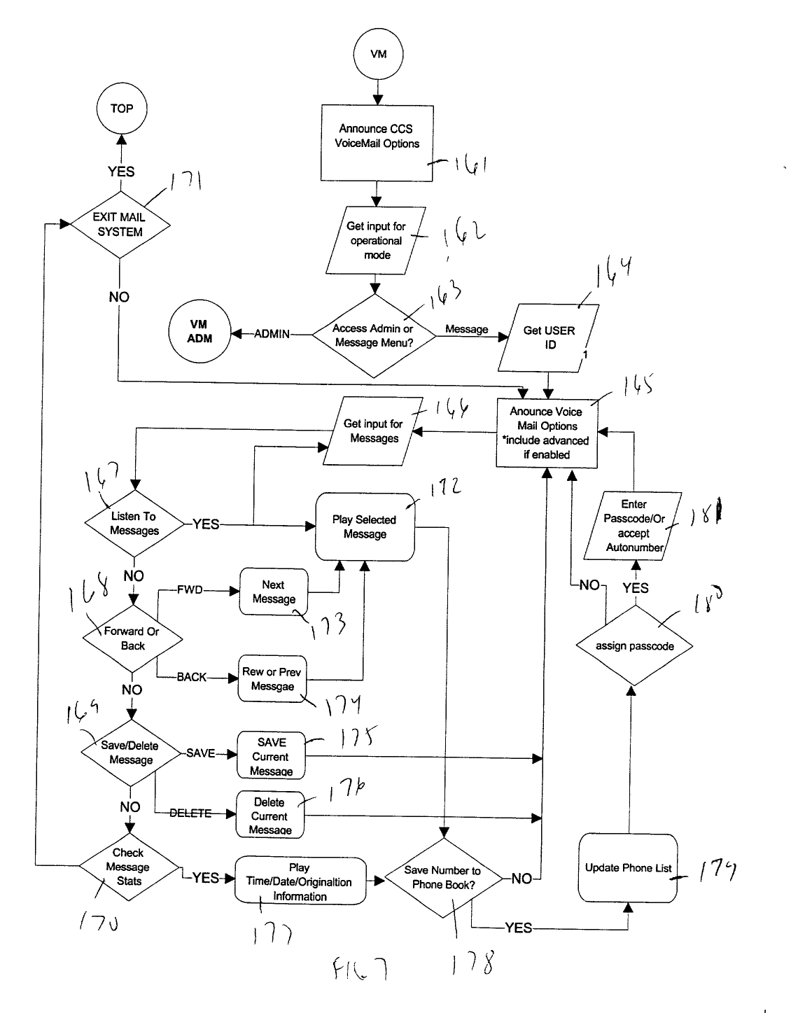

Reference is next made to FIG. 5, wherein the Systems Management Process Flow is shown. The System Management and Process Flow starts in branching Box 136, where a determination is made whether advanced menus are enabled. If so, then in Box 137, the system plays the main advanced menu message and then gets input from the user in Box 139. If no advanced menus are enabled, then the system, in Box 138, plays the main menu message and then gets the input from the user in Box 139. If the input is to enable or disable the CCS, in Box 140, the process flow shifts to the Caller Control System Enable (“CCSENA”) Process flow found in FIG. 6. If not, a determination is made whether it is an attempt to access voice mail in branching Box 141. If so, then the process flow shifts to the Voice Mail Flow found in FIG. 7. In branching Box 142, if the input is an enabled fax reception code, then process flow shifts to a fax processing flow, which is not shown. Essentially, the fax processing flow connects the telephone input to the fax machine or to the appropriate connection at the fax board in a PC to receive the fax. If it is determined in branching Box 143 that the input is an effort to edit the Call Directory, then the process flow shifts to a Call List Process Flow (“CL”), not shown in the other drawings. Essentially, this process flow allows one to add, amend or delete telephone numbers from an approved list or lists and to establish different mailboxes. In the event that the Enable/Disable Advance Functions, branching Box 144, determines that this feature is not indicated, then the process flow shifts to Exit section, Box 145 to determine if the exit parameters are correct. If yes, then process flows shifts to Box 146, where the pointers are updated and the control shifts back to the Ring Processing flow. In the event that appropriate exit parameters are not met, then process flow shifts to Box 147 where an Invalid Option Selected announcement is made and the process flow turns to the TOP of the System Management Process Flow in FIG. 5.

Reference is next made to FIG. 6, wherein the Caller Control System Enable Process Flow is depicted. In Box 148 the CCS Enable/Disable Options including the advanced options, if enabled, are announced to the user. Next, in Box 149, the System gets input for the operational mode. If the process flow in branching Box 150 determines that a Disable CCS Completely input has been received, then process flow shifts to branching Box 155, where a determination is made if the setting should be applied to all profiles. If yes, then user is asked to select a Global Profile in Box 156 and enter a Master Code or Cancel in Box 157. If the code is correct or cancel input has been received in branching Box 158, then the mode pointers are updated in Box 160 and process flow returns to Box 148. If the code is not correct, then process flow returns back to Box 157 and asks the user to reenter the master code or cancel. In the event that, in branching Box 155, the setting is not to be applied to all profiles, then flow proceeds to Box 159, where the user selects a profile and then the mode pointers are updated for that profile and process flow returns to Box 148. Similarly, in branching Boxes 151, 152, and 153, it is determined whether the CCS is in full automatic mode, full auto plus manual pass or setting the CCS to privacy mode. If the answer is yes, then process flow advances to branching Box 155, as described above. If not, process flow advances to branching Box 154, where the determination is made if the user wishes to exit the menu. If yes, then process flow shifts to the System Management Process Flow of FIG. 5. If not, then the process flow returns to Box 148 to repeat the options available.

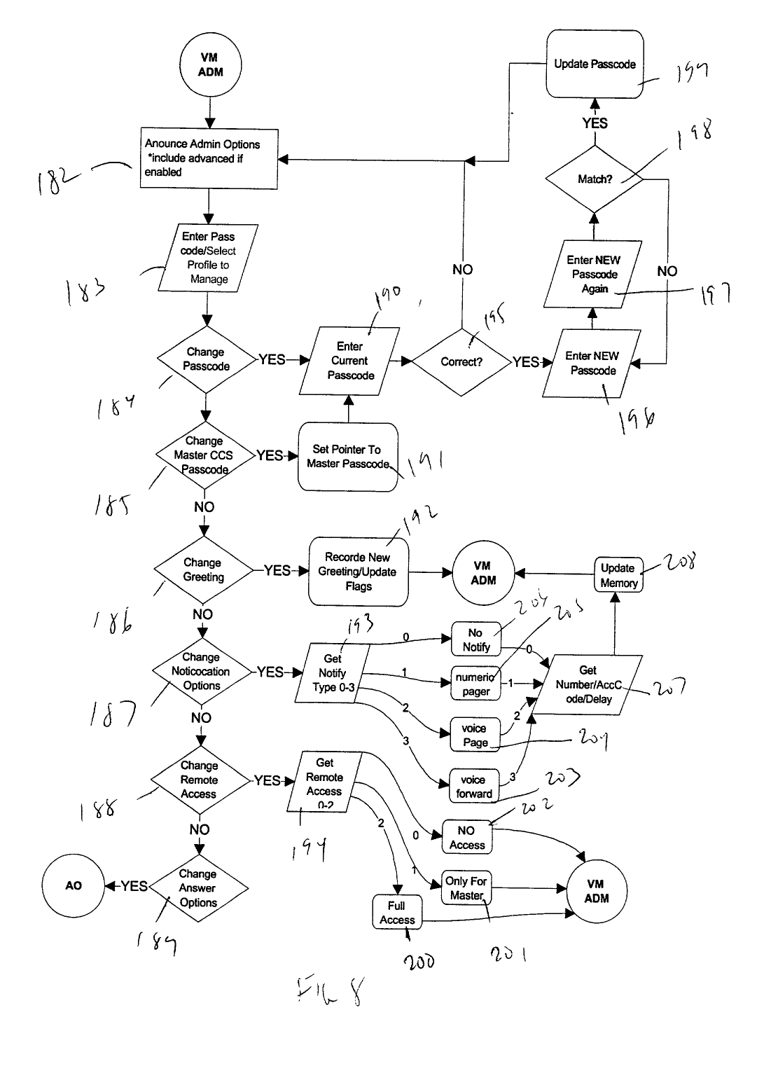

Reference is next made to FIG. 7, wherein the Voice Mail (“VM”) portion of the Caller Control System Operational Flow is depicted. In Box 161 the CCS Voice Mail options are announced. In Box 162 the system waits to receive operational mode inputs from the user. If the user indicates access to the administrative menu, then the process flow shifts to the Voice Mail Administration Process Flow found in FIG. 8. Otherwise, if the message menu is selected, flow shifts to Box 164, where the system awaits receipt of the user's I.D. Next, in Box 165, the system announces the Voice Mail options, including the advanced options, if enabled. Next, flow continues to Box 166, where the system gets input for the messages. In branching Box 167, the system determines whether the input is signaled to listen to messages. If so, the system plays a selected message in Box 172 and provides a signal to Box 166 in connection with waiting for input related to the messages. Next, a determination is made in Box 178 whether to save the number to the phone book. If the answer is no, the process flow returns to Box 165. If yes, the process flow shifts to Box 179 where the phone list is updated, and then Box 180, where a pass code is assigned to the number. If no pass code is assigned, control again shifts back to Box 165. However, if a pass code is assigned to the phone number, then the process awaits entry of the pass code or accepts an auto-selected number in Box 181. If the input was not a request to listen to messages in branching Box 167, the process flow, in branching Box 168, determines if the input was a request to move forward or backward through the messages. If it was forward, then the process flow continues to play the next message in Box 173, and then plays the selected message in Box 172, before continuing on to Box 178 as before. Similarly, if the input was a back signal, then the process flow continues to Box 174, where the system rewinds or goes to the previous message and then back to Box 172 to play the selected message and the remainder of the process flow as described. However, if the input message is not a forward or back input, in branching Box 169, the process determines whether there is a save/delete message. If it is a save message, then the process flow shifts to Box 175, where the current message is saved and then the flow continues back to Box 165. If the input signal is a delete message, then the current message is deleted in Box 176 and then returns control to Box 165. Next, if there was no save/delete message, the system checks in branching Box 170 whether in input was an effort to check the message statistics. If not, the process flow determines whether the user wishes to exit the mail system in branching Box 171. If yes, then the process flow shifts back to the TOP of the Caller Control System Process. Otherwise, the process flow returns to Box 165. If it is determined in branching Box 170 that the user wishes to check the message statistics then, in Box 177, the system plays the time, date and origination information and then determines whether there is a number to be saved to the phone book. And, again, the process flow continues as described above.

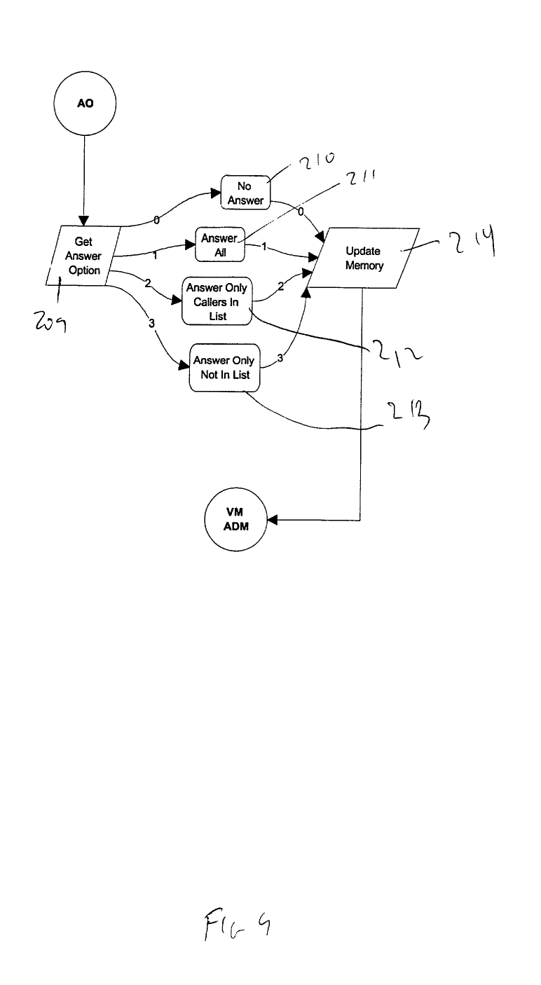

Reference is next made to FIG. 8 wherein the Voice Mail Administration Process (“VMADM”) is depicted. In Box 182 the system announces the administration options available, including advanced options if they have been enabled. Next, in Box 183 the user enters a pass code to select profiles to manage. Then, in branching Box 184, the system determines whether the input was to change the pass code. If so, the user must enter the current pass code during the process flow in Box 190 and in branching Box 195, the system determines whether the current pass code is correct. If not, the system loops back to Box 182. If the current pass code has been correctly entered, then the process flow advances to Box 196, where the user is prompted to enter the new pass code. Next, they are asked in Box 197, to re-enter the new pass code to confirm that it is accurately entered. Finally, in branching Box 198, the process determines whether the two entries of the new pass code were identical and match. If not, the user is prompted to re-enter the pass codes again. However, if the two entries of the new pass code match, the pass code is updated in Box 199 and control is returned to Box 182. similarly, if the pass code change was not selected, the checks, in branching Box 185, whether the signal was an effort to change the master CCS pass code. If so, the system sets the pointer to the master pass code in box 191 and then continues with the process flow of entering the current pass code in Box 190. If the signal was not a change to the Master CCS Pass Code, the process flow continues to branching Box 186, which determines whether the signal was an effort to change the greeting. If so, then, in Box 192, the user records a new greeting and the system updates the flags before the system returns to the TOP of the Voice Mail Administration Process (“VMADM”). Alternatively, if the signal was not an effort to change the greeting, in branching Box 187, the process determines whether the user was trying to change the notification options. If yes, then the user must input the notification type from 0 to 3 in box 193. If the input is 0, then the system goes to Box 206, which is a no notify mode, and then advances to Box 207, where the system gets the number, an account code and delay and updates the memory in Box 208 before returning control to the TOP of the VMADM Process Flow. Similarly, if the user has entered a 1 for the type, process flow shifts to Box 205 wherein the notification is a numeric pager and the process flow continues again with Boxes 207 and 208, prior to returning to the TOP of the VMADM Process Flow. If the notification type is set at 2, process flow advances to Box 204, which specifies a voice page, before continuing on as above. Finally, if the notification type is set at 3, this shifts to Box 203, which is the voice forward notification and then continues as above. If the determination is made in branching Box 187 that the user does not intend to change the notification options, control shifts down to branching Box 188, where a determination is made whether the user is attempting to change the remote access options. If yes, then process shifts to Box 194 and requests the user to input a remote access code between 0 and 2. If the remote access code is set at 0 for no access, control shifts to 202 before returning control to the TOP of the VMADM Process Flow. If a remote access code of 1 is entered, the system advances to Box 201, which provides access only for the master, before, again returning to the TOP of the VMADM Control. Finally, if the user inputs a 2, then full access is provided in Box 200 before returning to the TOP of the VMADM Process Flow. Finally, if the system in branching Box 188 does not detect an input to change the remote access, then the process flow shifts to branching Box 189, which determines whether the user wants to change the answer options. If yes, then the process flow shifts to the Answer Options Process Flow found in FIG. 9.

Reference is next made to FIG. 9 wherein the Answer Options Process Flow is shown. In Box 209 the process requests an answer option between 0 and 3 from the user. If the 0 option is selected, then the No Answer option in Box 210 is selected, the memory is updated in Box 214 and control is returned to the TOP of the VMADM Process Flow. If the user selects 1, the process shifts to the Answer All Box in 211 and then updates the memory in 214 before returning to the TOP of the VMADM Process Flow. Next, if the user selects option 2, the Answer Only Callers In List mode of Box 212 is selected and the memory is updated in Box 214 and control returns to the TOP of the VMADM Process Flow. Finally, if the user selects option 3, the Answer Only Not In List option of Box 213 is utilized, the memory is updated in Box 214 before returning to the TOP of the VMADM Process Flow.

Reference is next made to FIG. 10 wherein the Lock Processing and Do Not Disturb Process Flows are depicted. In the Lock Processing System, when the system answers the phone in Box 215, it determines whether there is a personal greeting selected in branching Box 216. If yes, then in Box 246 it plays a custom greeting before allowing the caller to enter a pass code in Box 218. In the event that there is no personal greeting, in Box 217 it plays a canned greeting and again reverts to Box 218 where it allows the caller to enter a pass code. If the pass code is not valid in branching Box 219, the process shifts to branching Box 223, where it determines whether the wrong pass code limit has been exceeded. If the user has entered the wrong pass code too many times, then the process flow shifts to the dump process which releases the phone line (hangs up) and resumes polling for new calls. If the wrong pass code limit has not been exceeded, the caller is again asked to enter a pass code in Box 218. If the pass code entered in branching Box 219 is valid, then in Box 220 the call is placed on hold and a ring signal is generated to the phones in the house or business. If the call is answered, then the process flow returns to the TOP of the Caller Control System Processing. If not, then the system determines whether the terminal ring count is reached in branching Box 222. Until the terminal ring count is reached the process loops back to Box 220 and thereafter continues on to the Leave Voice Mail (“LVM”) Process Flow found in FIG. 12.

The Do Not Disturb (“DND”) Process Flow, also found in FIG. 10, determines in branching Box 224 if there is a personal greeting. If there is, it plays the custom greeting in Box 225 and, if not, plays the canned greeting in Box 226 before going to the DUMP process which releases the phone line and resumes polling.

Reference is next made to FIG. 11 wherein the Ring Processing Caller I.D. Process is shown. In Box 227, the system waits for the Caller I.D. information until timeout is reached. Then in branching Box 228, it is determined whether the calling I.D. data is received. If not, the process loops back to Box 227 until the data is actually received. Once the data is received in Box 229, the system looks up the Caller I.D. information in the call list for this ring type. In branching Box 230, the process determines if the Caller I.D. is on the list. If so, the system in Box 231 generates tones onto the phone line to announce that the caller is approved and returns control to the TOP of the Caller Control System Process. If the call is not on the list in branching Box 230, the system determines in branching Box 232 whether the user wants the rejected calls announced. If not, the process goes directly to Box 234 where the caller list is updated but the user is not alerted and then returns to the TOP of the Caller Control System Process. Alternatively, if the user has set the system to announce rejected calls, the system in Box 233 generates tones to the phone line to announced that a caller was received but not approved, updates the caller list but does not otherwise alert the user before returning to the TOP of the Caller Control System Process.

Reference is next made to FIG. 12 wherein the Leave Voice Mail and Dump Processes are shown. In the Leave Voice Mail Process the system determines, in branching Box 235, whether there is a personal greeting. If there is, the system plays the custom greeting of Box 242 and if not, plays the canned greeting of Box 236. In Box 237, the system receives the message from the caller. In branching Box 238, the system determines whether it is set up for normal or advanced voice mail options. If advanced options are selected, then in Box 243, it plays the delivery options and gets the user delivery options in Box 244, before updating the memory and releasing the call in Box 239. If normal voice mail options are in effect, then the system merely updates the memory and releases the call in Box 239. Next, in branching Box 240, the system determines whether forwarding is enabled. If not, the system returns to the TOP of the Caller Control System Process. If so, the process advances to the Lookup Delivery Settings and Deliver Message in Box 245 before returning to the TOP of the Caller Control System Process.

It will thus be seen that the objects set forth above, among those made apparent in the proceeding description, are efficiently obtained and, since certain changes may be made in the above constructions and processes without departing from the spirit and scope of the invention, it is intended that all matter contained in the above description or shown in the accompanied drawings shall be interpreted as illustrative, and not in the limiting sense.

It will also be understood that the following Claims are intended to cover all of the generic and specific features of the invention, herein described and all statements of the scope of the invention which, as a matter of language, might be said to fall therebetween.

What is claimed is:

1. An improved Caller Control System for a receiving telephone line, comprising:
a Caller I.D. system for the telephone line;
a voice mail system for the receiving line; and
a Caller Control System coupled to the receiving line and the Caller I.D. and voice mail systems which provide password controlled protection against incoming telephone calls to the receiving line and which shunts incoming calls to a voice mail system or releases the call without ringing, unless the incoming caller properly accesses the Caller Control System with an appropriate password or is on an approved caller list.
